(19) United States
(12) Patent Application Publication
(10) Pub. No.: US 2025/0100899 A1
(43) Pub. Date: Mar. 27, 2025

(54) CAPSULE FOR LIQUID TREATMENT MEDIA

(71) Applicant: AARKE AB, Stockholm (SE)

(72) Inventor: Erik Wahlin, Värmdö (SE)

(21) Appl. No.: 18/728,258

(22) PCT Filed: Jan. 16, 2023
(86) PCT No.: PCT/EP2023/050851

§ 371 Date: Jul. 11, 2024

(30) Foreign Application Priority Data
Jan. 19, 2022 (SE) 2250047-4

(51) Int. Cl. C02F 1/00; C02F 103/02

(52) U.S. Cl. CPC C02F 1/003; C02F 2103/02; C02F 2201/003; C02F 2201/004; C02F 2201/006; C02F 2201/007; C02F 2307/04

(57) ABSTRACT

The present disclosure presents a capsule (1) for enclosing beverage treatment media, the capsule being adapted to be arranged in a beverage container (10), wherein the capsule (1) comprises an outlet end that is openable such that the beverage treatment media may be replaced and an inlet end that is not openable. The disclosure further presents a beverage container (10) with such a capsule (1).

### TECHNICAL FIELD

The present disclosure generally pertains to domestic liquid treatment, and more particularly to a hygienic, user-friendly and environmentally friendly capsule for water treatment media. The capsule is adapted to be inserted into a beverage container such as a water purification pitcher or carafe.

### BACKGROUND ART

Water purification pitchers with filter cartridges or capsules are commonly used to treat and contain tap water before drinking. These pitchers are typically intended for domestic use and may contain up to a few liters of beverage. Such pitchers may also be referred to as jugs or carafes. The filter cartridges are typically single use, and often made of plastic material.

An example of a prior art pitcher with a filter cartridge is disclosed in US20170007949A1. Prior art filters and beverage containers are generally marred with various drawbacks and problems as regards hygiene and ease of use.

### SUMMARY OF THE INVENTION

It is in view of the above considerations and others that the embodiments of the present invention have been made. The present disclosure recognizes the fact that the possibility to easily and properly clean prior art filter cartridges may be impaired by their design and material. For example, plastic filter cartridges may not, depending on the plastic material, be dishwasher safe. Plastic elements may scratch easily thereby increasing the need for regular cleaning as the scratches promote microbiological growth. For several reasons, including product life, it may be desirable to avoid plastic products. In addition, the prior art filter cartridges typically require at least one plastic or rubber sealing such as O-rings.

According to the present disclosure, there is provided a capsule for enclosing beverage treatment media. The capsule is adapted to be arranged in a beverage container and comprises an outlet end that is openable such that the beverage treatment media may be replaced and an inlet end that is not openable.

By the inlet end not being openable, a relatively simple design may be used to provide an inlet end that hinders the beverage treatment media from escaping and that directs all the beverage entering the capsule towards the beverage treatment media. The inlet end is subject to untreated beverage and possible debris entering the beverage container when being filled, typically with tap water. A simple design, with no joints between detachable parts, leads to few gaps or crevices which may promote bacterial growth or where dirt may accumulate. Such an inlet end may also be designed for easy cleaning, and may be manufactured entirely of metal.

The openable outlet end needs not be very tight, as the beverage that exits has already been treated by it passing through the capsule. A tightness that hinders the beverage treatment media from escaping may be sufficient. Such an outlet end may be manufactured entirely of metal. The capsule may be free of sealing material at the openable outlet end.

The capsule may be entirely made of metal. Metal material may be more hygienic and more environmentally friendly, especially in view of its long life, than plastic material. The capsule may thus not comprise any non-metallic components. The user may clean or sterilize metal parts of the capsule by hand washing, by using a dishwasher or by boiling in water.

The capsule may comprise a lower portion and an upper portion where the upper portion has a larger radial dimension than the lower portion. Such a design may facilitate the capsule being held in a beverage container. The capsule may for example be held by a capsule holder gasket that is elastically deformable and provides a liquid-tight friction fit between a portion or part of the beverage container and the capsule. The capsule holder gasket may be made of food grade silicone rubber. The increase in dimension between the lower portion and the upper portion may provide a radial protrusion that may rest on the capsule holder gasket. The radial protrusion may be referred to as a projection or a radial projection and may be formed by a bent portion of the capsule, which may be formed from sheet metal.

The capsule may comprise or consist of a main part that is adapted to enclose beverage treatment media and that forms the inlet end and a closure part that is releasably attachable to the main part and that forms the outlet end. The capsule may thus consist of few loose parts. The widths of the main part and the closure part may be 40-80 mm (millimeters) and both may have a length of at least 10 mm. The length is measured along a longitudinal axis of the capsule and the width is measured transverse said axis. The main part and the closure part may both provide external grip surfaces for ease of use.

The main part may have the general shape of a hollow, circular straight cylinder. The closure part may have the general shape of a hollow, circular straight cylinder. The side wall of the main part, i.e. that wall that forms the cylinder, may be liquid-tight. The side wall of the closure part, i.e. that wall that forms the cylinder, may be liquid-tight.

The main part and the closure part may comprise cooperating releasable attachment means to releasably attach the closure part to the main part. The releasable attachment means may e.g. form a thread connection, a bayonet connection or an interference fit connection.

The main part and the closure part may be shaped such that an openable joint there between is sufficiently tight to not allow any beverage treatment media leaking out through the joint. The joint may be seal-less, thus free from any sealing material. The closure part may completely overlap a downstream portion of the main part.

The upstream end of the main part may comprise an extension portion protruding axially upstream from the main part body. The extension portion may have a larger outer cross-section than the main part body. Thus, the extension portion may protrude radially from the main part body. The extension portion may provide the aforementioned radial projection.

The extension portion may be configured such that a user may grip the extension portion by hand to pull the capsule out of the beverage container. The extension portion may have a width of 40-80 mm and a length of at least 10 mm. The extension portion may be configured such that the user pay push the extension portion when arranging the capsule inside a beverage container. The extension portion may comprise a rounded brim that may be gripped and also pushed. The extension portion may be formed by sheet metal.

The capsule may comprise an inlet sieve that is adapted to allow the passage of beverage but hinder the passage of beverage treatment media. The inlet sieve may be configured such that the beverage may pass through and along the inlet sieve and to the beverage treatment media. Such an inlet sieve may increase the flow rate through the inlet sieve and to the beverage treatment media.

For example, the inlet sieve may extend in the vertical direction such that the beverage may flow along the inlet sieve in the vertical direction and to the beverage treatment media. The inlet sieve may comprise a portion that extends downwards. The inlet sieve may extend from an upper end of a space for enclosing the beverage treatment media inside the capsule and at least 5 mm, for example 10 mm or 15 mm downwards into the space, to make contact with the beverage treatment media. The fact that the inlet end of the capsule is not openable will reduce the risk of mechanical damage to the inlet sieve. Also, the inlet sieve may be mechanically protection by its position inside the space for enclosing the beverage treatment media.

The capsule may comprise an outlet sieve that is adapted to allow the passage of beverage but hinder the passage of beverage treatment media. The inlet sieve may be coarser than the outlet sieve.

The capsule may comprise an inlet opening and an outlet opening wherein the outlet opening is smaller than the inlet opening. The capsule may comprise a single inlet opening. The capsule may comprise a single outlet opening.

The capsule may alternatively be referred to as a filter capsule or a filter cartridge.

The inlet sieve may find use in beverage treatment media capsules of another general design than the one described herein. Thus, in another aspect of the present disclosure, there is provided a capsule for enclosing beverage treatment media wherein the capsule comprises an inlet that comprises an inlet sieve as described herein.

The present disclosure further provides a beverage container comprising a capsule as described above. The beverage container may comprise an outer enclosure made of glass or metal, and an upstream volume for untreated beverage wherein the beverage container is configured to hold the capsule such that the inlet end is arranged inside the upstream volume and the outlet end is arranged downstream the upstream volume.

The beverage container may further comprise a downstream volume for treated beverage. The outlet end of the capsule may be arranged in the downstream volume. As has been mentioned, the capsule may be free of sealing material at the openable outlet end and thus no sealing material will be located in the volume for treated beverage.

### BRIEF DESCRIPTION OF THE DRAWINGS

The present invention will be described further below by way of example and with reference to the enclosed drawings, in which:

FIG. 1 is a isometric view of a capsule for water treatment media,

FIG. 2 shows the capsule of FIG. 1 when opened,

FIG. 3 is an exploded view of the capsule of FIGS. 1 and 2, and

FIG. 4 is an exploded view of a beverage container together with the capsule of the previous figures.

### DETAILED DESCRIPTION OF EMBODIMENTS

Embodiments of the present disclosure will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like reference numbers refer to like elements throughout the description and figures.

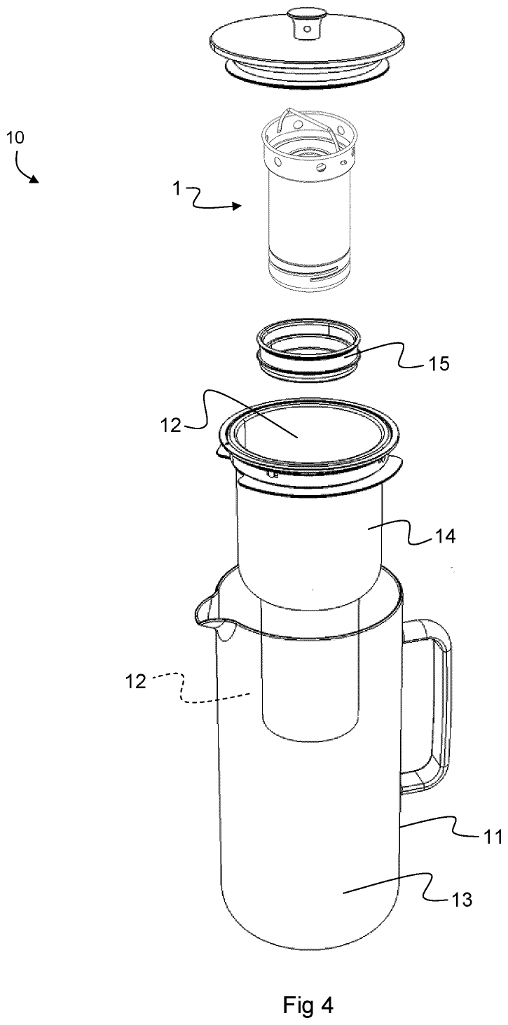

FIG. 4 shows a beverage container 10 in form of a water purification carafe or pitcher. The beverage container 10 may alternatively be referred to as a water treatment carafe or pitcher or as a water filter carafe or filter. The water purification beverage container 10 may releasably hold a capsule 1 for a beverage treatment media that will be described in detail below. The beverage container 10 comprises an outer enclosure 11 preferably made of glass or metal. In the beverage container 10 are defined an upstream volume 12 for untreated beverage and a downstream volume 13 for treated beverage. The beverage container 10 is configured to hold the capsule 1 such that untreated beverage may flow from the upstream volume 12 through the capsule 1 and to the downstream volume 13.

More in detail, the beverage container 10 may comprise a hopper part 14 that is arrangeable inside the outer enclosure 11 to form the upstream volume 12 and to separate the upstream volume 12 from the downstream volume 13. The hopper part 14 may be made of glass or metal. Further, the beverage container 10 may comprise a capsule holder gasket 15 for tightly holding the capsule 1 inside the hopper part 14. The capsule holder gasket 15 may be elastically deformable and provide a liquid-tight friction fit between the hopper part 14 and the capsule 1. The capsule holder gasket 15 may be made of food grade silicone rubber. Such silicone rubber may consist exclusively of silicon, oxygen, hydrogen and carbon.

As is clear from FIG. 4, the beverage container 10 is configured to hold the capsule 1 such that the capsule inlet end 1a is arranged inside the upstream volume 12 and the capsule outlet end 1b is arranged downstream the upstream volume 12. The capsule 1 may, as in the present embodiment, be of a shape that facilitates the capsule 1 being held or arranged in the beverage container 10. As is shown, the outer shape of the capsule 1 may correspond to an inner shape of the capsule holder gasket 15. The capsule holder gasket 15 may have a circular holder opening and the capsule 1 may have a corresponding outer circular cross-section, as is clear from FIG. 4. To prevent the capsule 1 from being pushed all the down through the capsule holder gasket 15, the capsule 1 may have a larger radial dimension at the inlet end 1a than at the outlet end 1b. In other words, the capsule 1 may be provided with a projection 3h that protrudes radially from the capsule 1. The projection 3h may rest on the capsule holder gasket 15 or a similar device of a beverage container 10.

In use, a user fills the upstream volume 12 with a beverage to be treated, typically tap water. The untreated water flows from the upstream volume 12, through the capsule 1 and to the downstream volume 13 where the treated water is collected. Thus, when passing thought the capsule 1, the water is treated by the water treatment media disposed within the capsule 1. The water treatment media may be configured to filter and/or treat the water. The water treatment may e.g. comprise adjusting the pH value, removing unwanted flavours, and adding minerals to the water.

For further details on the beverage container 10, reference is made to the co-pending Swedish patent application 2150319-8. It is to be understood that the capsule 1 of the present disclosure may be used in other beverage containers.

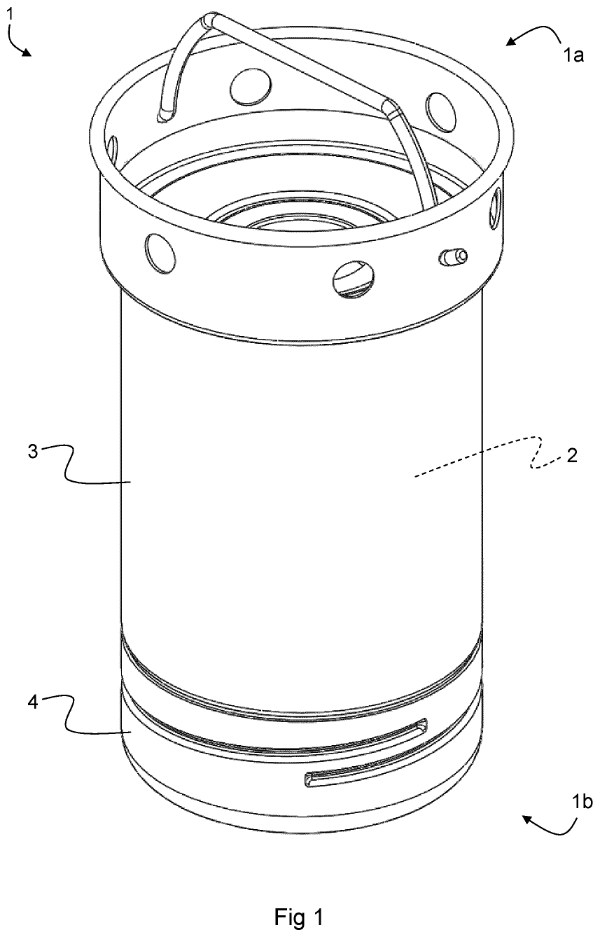

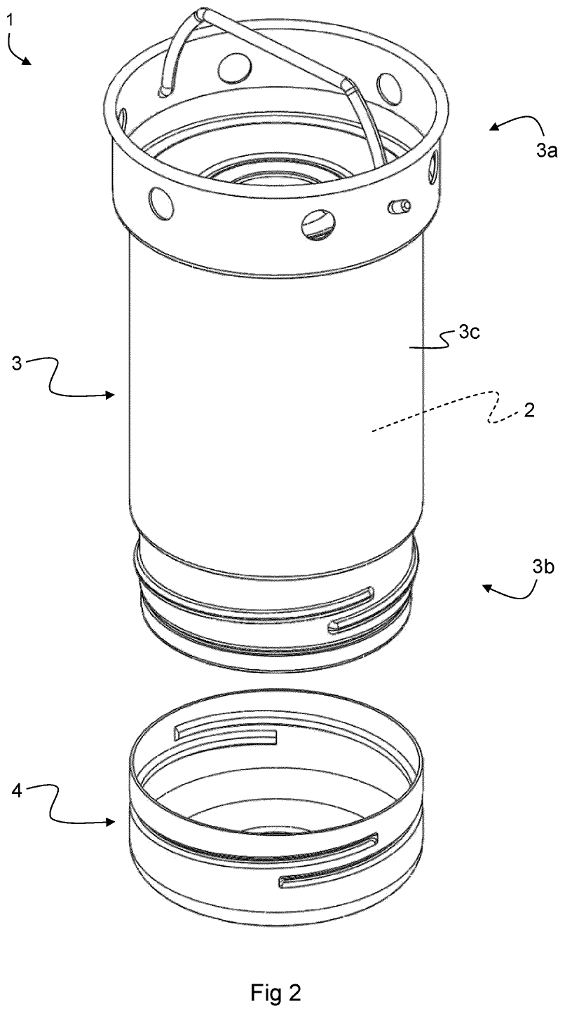

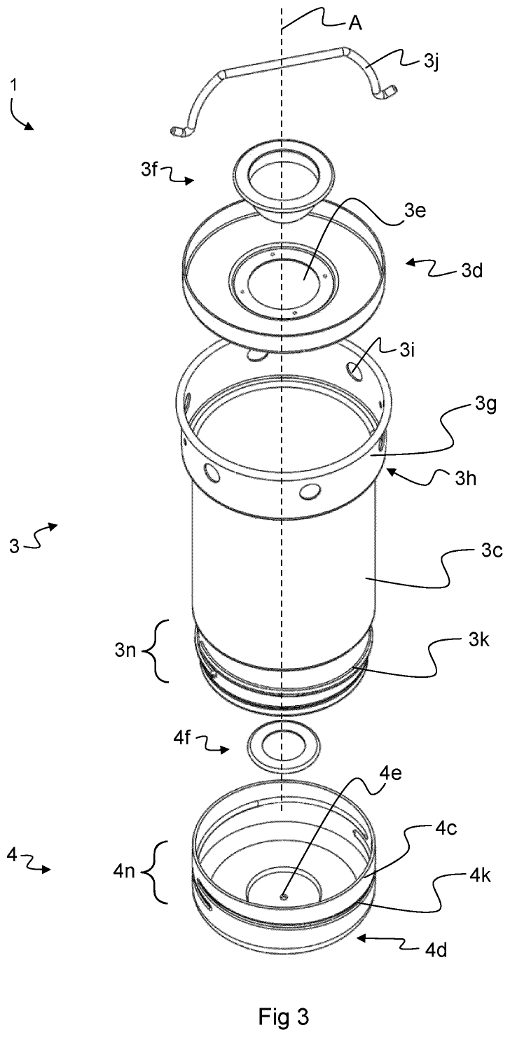

FIGS. 1 to 3 show the capsule 1 in more detail. The capsule 1 extends along a longitudinal axis A (illustrated in FIG. 3) and comprises an openable outlet end 1b and a non-openable inlet end 1a. In use (as illustrated in the figures where the longitudinal axis A is aligned with a vertical axis), the outlet end 1b is located below the inlet end 1a such that the beverage flows by gravity into the inlet end 1a, through the capsule 1 and out of the outlet end 1b.

The capsule 1 is preferably made of metal, and more precisely from stainless steel. Other conceivable metals include aluminium (aluminum in US English) or titan. In the embodiments of the present disclose, the capsule 1 is made of stainless steel sheet material.

As is shown in the embodiment of FIGS. 1 to 3, the capsule 1 may comprise a main part 3 and a closure part 4. The closure part 4 may alternatively be referred to as a lid part. The main part 3 may be made from sheet metal and thus be thin-walled, as in the present example. The main part 3 may have a main part body 3c with a first end 3a and a second end 3b. In the present embodiment, the main part body 3c has the form of a hollow cylinder forming a space for the beverage treatment media. More precisely the main part body 3c has the form of a hollow, circular straight cylinder. The circumferential wall, or side wall, of the main part body 3c is liquid-tight. In use, the second end 3b is located below the first end 3a.

Referring primarily to FIG. 3, attached to the first end 3a of the main part 3 is an annular inlet disc 3d that comprises an inlet opening 3e. An inlet mesh or sieve 3f is attached to the inlet disc 3d and is arranged and shaped to extend through the inlet opening 3e from an upstream side of the inlet disc 3d to a downstream side of the inlet disc 3d. The inlet sieve 3f may extend in the vertical direction and into the main part 3. In FIG. 3, the inlet sieve 3f essentially has the shape of a semi-sphere with the rounded part facing downwards, i.e. into the main part body 3c. In the current embodiment, the inlet sieve 3f extends approximately 10 mm into the space for the beverage treatment media. In other words, the inlet sieve 3f extends 10 mm downstream from the inlet opening 3e. The inlet sieve 3f may in other embodiments have other shapes (e.g. generally dome-shaped, pyramid-shaped, conical or cylindrical) but should extend at least 5 mm into the into the beverage treatment media space. The inlet sieve 3f is protected from mechanical damage by the surrounding main part body 3c.

The second end 3b of the main part 3 is entirely open. The terms “upstream” and “downstream” refer to the flow of a beverage through the capsule 1. When in use, as depicted in the attached figures, upstream corresponds to upper and downstream corresponds to lower.

The inlet opening 3e is preferably, as shown, positioned at a distance from the inner walls of the main part body 3c. Thereby the flow through the inlet opening 3e is directed to the beverage treatment media at a distance from the inner walls of the main part body 3c. In the current embodiment, the inlet opening 3e is positioned centrally with respect to the main part body 3c (as seen in a horizontal plane during use).

As has been mentioned, in the vicinity of the inlet end 1a, the capsule 1 may be shaped to protrude radially so as to facilitate the capsule 1 being held by, or attached to the beverage container 10. The first end 3a of the main part 3 may comprise an extension portion 3g protruding axially upstream from the main part body 3c. As is shown, the extension portion 3g may have a larger outer cross-section than the main part body 3c. Thus, the extension portion 3g may protrude radially from the main part body 3c.

Thus, in the current embodiment, there is a projection 3h in the form of an annular step or transition formed between the main part body 3c and the extension portion 3g. The projection 3h is formed by a curvature, or bent portion of the thin-walled main part 3. The above described capsule holder gasket 15, or a similar device, may hold capsule 1 by the projection 3h resting on the capsule holder gasket 15 that surrounds the main part 3, see FIG. 4. In other words, the capsule 1 may comprise a lower portion 3c (the main part body) and an upper portion 3g (the extension portion 3g) where the upper portion 3g has a larger radial dimension than the lower portion 3c.

The extension portion 3g may comprise radial openings 3i (FIG. 3) for flow of untreated beverage though the extension portion 3g. The purpose of the radial openings 3i is best understood from FIG. 4. If the capsule 1 is positioned within the hopper part 14, or a similar device, with the inlet end 1a arranged inside the upstream volume 12, then the radial openings 3i will facilitate the flow of all beverage within the upstream volume 12 though the extension portion 3g.

Since the extension portion 3g may extend axially upstream from the main part body 3c, more precisely from the projection 3h on which the capsule 1 may rest, the user may conveniently grip the extension portion 3g by hand to pull the capsule 1 out of the beverage container 10. To facilitate the user grasping the capsule 1, a handle 3j may be attached to the extension portion 3g as is illustrated. Alternatively, in embodiments lacking an extension portion 3g, the handle may be attached (not shown) to the main part body 3c. The handle 3j may, as shown, extend across the hollow capsule 1.

The upper end surface of the main part 3, which in the disclosed embodiment is formed by the upper end or brim of the extension portion 3g, may be rounded such that a sharp edge is avoided. The rounded brim may be obtained by bending or rolling the uppermost section of the sheet metal radially outwards. Such a rounded brim further facilitates gripping the extension portion 3g should no handle 3j be provided.

The second or downstream end 3b of the main part 3 may as is illustrated be provided with attachments means 3k that cooperate with attachments means 4k on the closure part 4. For example, as shown, the main part 3 and the closure part 4 may be provided with cooperating threads 3k, 4k. As alternatives to a thread connection 3k, 4k, a bayonet connection or an interference fit connection may be provided to releasably attach the closure part and the main part 3 to one another. The main part 3 and the closure part 4 should be configured to be releasably attachable to one another, with the joint there between being sufficiently tight to not let any loose beverage treatment media leak out through the joint.

The second end 3b of the main part 3 may comprise a narrowed portion 3n of reduced cross-section on which the threads 3k (external threads 3k) are arranged. The axial extension of the narrowed portion 3n may correspond to the axial length 4n of the closure part 4. As is understood from FIG. 3, in the disclosed embodiment the main part body 3c bottoms against the outlet disc 4d.

The closure part 4 may be thin-walled and may have the general shape of a typical can lid. In the present embodiment, the closure part 4 comprises a closure part body 4c in the form of a hollow, circular cylinder. The closure part body 4c comprises the attachments means 4k (internal threads 4k). The upstream end of the closure part body 4c is entirely open and will face the open end 3b of the main part 3. The closure part 4 further comprises an annular outlet disc 4d at the downstream end of closure part body 4c. The closure part body 4c may completely overlap the narrowed portion 3n, as shown in FIG. 1.

The downstream end of the closure part 4 comprises an outlet opening 4e. More precisely, the outlet opening 4e is formed in the outlet disc 4d. An outlet mesh or sieve 4f is attached to the upstream side of the outlet disc 4d and covers the outlet opening 4e. The outlet sieve 4f may have a substantially larger area than the outlet opening 4e. The outlet opening 4e is preferably, as is shown, positioned at a distance from the inner walls of the closure part body 4c and also from the main part body 3c. In the current embodiment, the outlet opening 4e is positioned centrally with respect to the main part body 3c.

As is shown in FIG. 3, the outlet disc 4d may comprise an outlet sieve indentation that receives the outlet sieve 4f. The outlet sieve 4f may (as shown in FIG. 3) comprise an annular frame that holds an outlet sieve or mesh structure. The annular frame may be attached, e.g. welded, to the outlet disc 4d, more precisely to the outlet sieve indentation.

The outlet disc 4d and the outlet sieve 4f may be shaped such that there is a distance between the outlet sieve 4f and the outlet disc 4d wherein the outlet opening 4e is formed. Tests have shown that in this way, and in particular if the outlet sieve 4f has a larger area than the outlet opening 4e, clogging of the outlet sieve 4f may be prevented or at least mitigated.

The size of the capsule 1 is selected such that it may contain an appropriate quantity of beverage treatment media. Moreover, the axial and radial dimensions are selected such that a user may conveniently open the capsule 1 to replace the beverage treatment media. Preferable, the width (transverse axis A) of the capsule is 40-80 mm and the length (longitudinal length, along axis A) of each one of the main part 3 and the closure part 4 is at least 10 mm to provide a good grip.

The main part 3 and the closure part 4 may both afford external grip surfaces providing good grip for ease of use, e.g. for opening the capsule 1. In detail, the main part body 3c forms an outer or external grip surface of the main part 3. The closure part body 4c forms an outer or external grip surface of the closure part 4.

The main part body 3c, the extension portion 3g, the inlet disc 3d and the inlet sieve 3f may be fixedly attached to one another e.g. by welding. The main part body 3c and the extension portion 3g may be integrally formed in one piece. The handle 3j may, as illustrated, be releasably attached to the main part body 3c, more precisely by the ends thereof being held in opposing radial holes of the extension portion 3g.

The closure part body 4c and the outlet disc 4d may be fixedly attached to one another, they may, as is illustrated, be integrally formed in one piece. The outlet sieve 4f may be fixedly attached to the outlet disc 4d, e.g. by welding.

The attachment means 3k, 4k may be integrally formed with the main part 3 and the closure part 4, respectively. In this embodiment, the attachment means 3k, 4k are provided by threads that are formed by pressing the sheet metal material of the main part 3 and the closure part 4.

Further features and advantages of embodiments of the present disclosure will become clear from the below description of typical steps of use of the capsule 1.

The capsule 1 may be delivered with the main part 3 and the closure part 4 attached to one another, e.g. screwed to one another. The user may clean or even sterilize the capsule 1 by hand washing, by using a dishwasher or even by boiling in water. Before cleaning or sterilizing, the user may separate the main part 3 and the closure part 4. If the capsule 1 is used together with a silicone rubber capsule holder gasket 15 as describe herein, the capsule holder gasket 15 may also be hand washed, washed in a dishwasher or boiled.

Next, the user may fill the capsule 1 with the beverage treatment media. The beverage treatment media is typically provided in granular form. The beverage treatment media may be loosely poured in the main part 3 that may then be closed by the closure part 4. As is clear from the figures, in particular FIG. 4 that shows the capsule 1 and a beverage container 10, the capsule 1 is held upside down when beverage treatment media is poured into the space inside the main part 3. Alternatively, the beverage treatment media may be contained in a pouch or bag that is placed inside the capsule 1.

If the beverage treatment media is loosely provided inside the capsule 1 (without an enclosing bag or pouch), the capsule 1 should be sufficiently tight to not let any beverage treatment media, e.g. granules, leak out from the capsule 1 during use. Such tightness may be achieved by the main part 3 and the closure part 4 being shaped such that the main part body 3c bottoms against the outlet disc 4d. The attachment means in form of threads 3k, 4k and closely matched outer dimension of the narrowed portion 3n and inner dimension of the closure part body 4c provide additional tightness. There is no need for a sealing element, such as a gasket or seal, to obtain the required tightness.

The present design of the main part 3 and the closure part 4, where then closure part 4 overlaps the downstream end of the main part brings the advantage that there is a low risk that any beverage treatment media ends up in the interface between then main part 3 and the closure part 4, more precisely between the narrowed portion 3n and the closure part body 4c.

If the inlet sieve 3f extends downstream into the main part 3, i.e. into the space for the beverage treatment media, then the inlet sieve 3f may efficiently make contact with the beverage treatment media within the main part body 3c. Such an inlet sieve 3f may make contact with the beverage treatment media also in the event that the space is not entirely filled with beverage treatment media. The present hemispherical inlet sieve 3f extends vertically downwards into the beverage treatment media as is clear from FIG. 3.

The capsule 1 containing the beverage treatment media may be arranged in a beverage container 10 like the one shown in FIG. 4. The capsule is then pushed downwards into the holder opening of the capsule holder gasket 15 that is positioned inside the hopper part 14. The user may for example push the rounded brim of the extension portion 3g. When the projection 3h of the capsule 1 reaches the capsule holder gasket 15, the capsule 1 is correctly positioned in the beverage container 10. The capsule holder gasket 15 is now positioned around the capsule 1 and enclosing the transition between the main part body 3c and the extension portion 3g, with the radial openings 3i located just above the capsule holder gasket 15. The capsule 1 may be used in other beverage containers, which should preferable comprise a holding opening or similar that may tightly hold the capsule 1 in place.

The user may now initiate the beverage treatment by pouring beverage to be treated into the upstream volume 12. The beverage flows through the inlet sieve 3f, i.e. from an upstream side of the inlet sieve 3f to and downstream side of the inlet sieve 3f. Now, if the inlet sieve 3f, or more precisely the downstream side of the inlet sieve 3f, is in contact with the beverage treatment media located inside the capsule 1, the flow rate through the inlet sieve 3f and to the beverage treatment media may be considerably increased. If there is no contact between the inlet sieve 3f and the beverage treatment media, the flow is dependent on the beverage dripping from the inlet sieve 3f to the beverage treatment media and the flow rate is much lower. It is believed that the contact between the inlet sieve 3f and the beverage treatment medial increases the flow rate thanks to capillary action.

It is believed beneficial if the capsule 1 is configured such that the beverage passes there through in 3-5 minutes. A quicker process is typically desired by the user, whereas a proper beverage treatment may require a certain amount of time.

After a certain number of uses or a certain period of use, the beverage treatment media should be replaced. The user may use the handle 3f or the rounded brim for pulling the capsule 1 out of the beverage container 10. The user next detaches the closure part 4 from the main part 3 to empty the main part 3 of its used beverage treatment media. The steps of use of the capsule 1 may now start anew, for example by washing the capsule 1 in a dishwasher.

Tests have shown that in order to obtain an optimal flow through the capsule 1, the inlet to the beverage treatment media should be configured to allow a higher flow rate than the outlet from the beverage treatment media.

The inlet to the beverage treatment media may be formed by the inlet opening 3e and the inlet sieve 3f. Thus, the inlet flow is affected by the area of the inlet opening 3e and the coarseness of the inlet sieve 3f. As has been mentioned, the inlet flow may be increased by the inlet sieve 3f making contact with the beverage treatment media.

The outlet from the beverage treatment media may be formed by the outlet opening 4e, the outlet sieve 4f and the (leakage through) openable joint between the main part 3 and the closure part 4. Thus, the outlet flow is affected by the area of the outlet opening 4e, the coarseness of the outlet sieve 4f and the tightness of the openable joint. In the present embodiment, the inlet sieve 3f is coarser than the outlet sieve 4f. In addition, the area of the outlet opening 4e is substantially smaller than the area of the inlet opening 3e. It is believed that in particular the area of the outlet opening 4e has a large influence of the flow rate. A suitable area of the present single outlet opening 4e is 3 to 10 square millimeters.

A relatively coarse inlet sieve 3f is beneficial as it may be mechanically strong and thus resistant to being deformed or damaged during handling, for example as a result of a user pressing it or as a result of contact with the beverage treatment media within the beverage treatment media space. Further, a relatively coarse inlet sieve 3f will not substantially impede the flow there through. A relative fine outlet sieve 4f is beneficial as it effectively hinders the beverage treatment media from escaping there through.

Modifications and other variants of the described embodiments will come to mind to ones skilled in the art having benefit of the teachings presented in the foregoing description and associated figures. Therefore, it is to be understood that the embodiments are not limited to the specific example embodiments described in this disclosure and that modifications and other variants are intended to be included within the scope of this disclosure.

For example, the contact between the inlet sieve and the beverage treatment media may be obtained by the inlet sieve comprising a downwards protruding pin or similar, i.e. by an essentially flat sieve portion together with a portion that protrudes downwards to make contact with the beverage treatment media.

In the above embodiments, the capsule 1 comprises an inlet to the beverage treatment media and an outlet from the beverage treatment media. Between said inlet and outlet, the capsule 1 is closed, e.g. has a liquid-tight side wall. In other embodiments (not disclosed), 10 a lower portion of the side wall may be furnished with a side wall outlet opening (and sieve) allowing exit of treated beverage. Such side wall outlet opening(s) may replace or supplement the above-described outlet opening (and sieve 4f). The capsule 1 may come to use in other beverage treatment apparatuses than portable pitchers or carafes, such as fixed installations for treatment of tap water.

1. A capsule for enclosing beverage treatment media, the capsule configured to be arranged in a beverage container, wherein the capsule comprises:
an outlet end that is openable such that the beverage treatment media may be replaced; and
an inlet end that is not openable.

2. The capsule of claim 1, wherein the capsule is entirely made of metal.

3. The capsule of claim 1, wherein the capsule does not comprise any non-metallic components.

4. The capsule of claim 1, wherein the capsule is free of sealing material at the openable outlet end.

5. The capsule of claim 1, further comprising:
a main part configured to enclose the beverage treatment media and to form the inlet end; and
a closure part configured to be releasably attachable to the main part and to form the outlet end.

6. The capsule of claim 5, wherein the main part and the closure part are shaped such that an openable joint there-between is configured to be sufficiently tight to not allow any beverage treatment media to leak out through the joint.

7. The capsule of claim 6, wherein the joint is seal-less.

8. The capsule of claim 1, further comprising an inlet sieve configured to allow the passage of beverage but hinder the passage of the beverage treatment media.

9. The capsule of claim 8, wherein the inlet sieve is configured to enable the beverage to pass through and along the inlet sieve and to the beverage treatment media.

10. The capsule of claim 8, wherein the inlet sieve extends in a vertical direction such that the beverage may flow along the inlet sieve in the vertical direction and to the beverage treatment media.

11. The capsule of claim 9, wherein the inlet sieve extends from an upper end of a space for enclosing the beverage treatment media inside the capsule and at least 5 mm downwards into the space.

12. The capsule of claim 8, further comprising an outlet sieve configured to allow the passage of beverage but hinder the passage of the beverage treatment media.

13. The capsule of claim 12, wherein the inlet sieve is coarser than the outlet sieve.

14. A beverage container comprising the capsule of claim 1.

15. The beverage container of claim 14 further comprising:
an outer enclosure made of glass or metal, and
an upstream volume for untreated beverage,
wherein the beverage container is configured to hold the capsule such that the inlet end is arranged inside the upstream volume and the outlet end is arranged downstream of the upstream volume.

16. The capsule of claim 9, wherein the inlet sieve extends in a vertical direction such that the beverage may flow along the inlet sieve in the vertical direction and to the beverage treatment media.

17. The capsule of claim 16, wherein the inlet sieve extends from an upper end of a space for enclosing the beverage treatment media inside the capsule and at least 5 mm downwards into the space.

18. The capsule of claim 17, further comprising an outlet sieve configured to allow the passage of beverage but hinder the passage of the beverage treatment media, and wherein the inlet sieve is coarser than the outlet sieve.
